(19) United States
(12) Patent Application Publication
(10) Pub. No.: US 2004/0170774 A1
(43) Pub. Date: Sep. 2, 2004

(54) Polymeric compositions

(76) Inventors: Luc Moens, Sint-Genesius-Rhode (BE); Kris Buysens, Oudenaarde (BE); Daniel Maetens, Brussels (BE)

Correspondence Address: Wenderoth Lind & Ponack, Suite 800, 2033 K Street NW, Washington, DC, 20006, US

(21) Appl. No.: 10/484,780

(22) PCT Filed: Jul. 23, 2002
(86) PCT No.: PCT/EP02/08189

(30) Foreign Application Priority Data
Jul. 26, 2001 (EP) 01118129.4

(51) Int. Cl. B05D 3/02; B05D 3/06

(52) U.S. Cl. 427/553; 427/385.5; 427/508; 427/551; 427/558

(57) ABSTRACT

There is described a radiation curable powder composition which comprisesa) 10 to 90% weight of an ethylenically unsaturated polyester and/or acrylic copolymer having an “in chain” unsaturation from 0.35 to 3.50 milliequivalents of double bonds per gram resinb) 10 to 90% weight of an ethylenically unsaturated (hydrogenated) polyphenoxy resin having a vinyl group, an allyl group, a(meth)acrylate ester group or a diacid or anhydride containing unsaturated groups; andc) 0 to 30% weight of an ethylenically unsaturated oligomer.

The present invention concerns powder compositions, hardenable by radiation usable as paint or varnish, comprising a mixture of at least one ethylenically unsaturated resin having “in chain” unsaturated groups and at least one (hydrogenated) polyphenoxy resin having ethylenically unsaturated groups reactable with the “in chain” unsaturated groups of the ethylenically unsaturated resin and with the functional groups of an ethylenically unsaturated oligomer optionally added to the binder, the oligomer having functional groups also capable of reacting with the “in chain” unsaturated groups of the ethylenically unsaturated resin.

The powder compositions of the present invention may be especially suited for coating over metal and heat-sensitive substrates and combine, upon melting at low temperatures and curing by radiation, a series of properties such as good flow and film hardness along with an outstanding solvent resistance and flexibility. These radiation curable powders may exhibit improved flexibility and chemical resistance Powder coatings, which are dry, finely divided, free flowing, solid materials at room temperature, have gained considerable popularity in recent years over liquid coatings. Despite their many advantages, nowadays thermosetting powder coatings generally are cured at temperatures of at least [140° C.] Below this recommended temperature the coatings have poor appearance as well as poor physical and chemical properties. In consequence of this restriction, powder coatings are generally not employed in coating heat-sensitive substrates such as wood and plastic or assembled metallic parts containing heat-sensitive compounds. Heat-sensitive substrates or compounds both demand low curing temperatures, preferably below [140° C.,] to avoid significant degradation and/or deformation.

Low temperature radiation curable powders have recently been proposed as a solution to this problem.

The use of unsaturated resins, eventually in combination with unsaturated oligomers, as a binder for radiation curable powder coatings already is subject of a considerable number of patents and patent applications.

UV curable powder coating compositions derived, from ethylenically unsaturated group containing polyesters, acrylic copolymers or epoxy resins, among others, already have been extensively illustrated.

U.S. Pat. No. 3,974,303 (Kansai Paint Co Ltd. ) describes different unsaturated resins such as methacryloyl group containing polyesters or acrylic copolymers. EP [2164254] (BASF) describes powder coatings based on unsaturated polyesters, acrylic copolymers, epoxy resins and other polymers containing unsaturated double bonds.

U.S. Pat. No. 4,129,488 (SCM Corporation N.Y.) discloses powder paint coatings suitable for [UV] curing comprising a specific spatial arrangement of ethylenically unsaturated polymers. The (meth) acrylic unsaturated polymer is a spatial specific epoxy-polyester polymer, produced in a step-wise process, with a number average molecular weight between 1000 and 10 [000,] providing suitable crystallinity to the free flowing powder and exhibiting a sharp melting point, between 80 and 200° C., for excellent flow.

Terminal methacryloyl group containing semi-crystalline polyesters or blends of them with terminal methacryloyl group containing amorphous polyesters, already are claimed in e. g.

EP 0739922 and WO 98/18862 (UCB) respectively. Paint properties such as flow, hardness, mechanical properties, solvent resistance (MEK) are discussed.

As generally is known from those skilled in the art, powder coatings whether they are thermosetting or radiation curable, only prove satisfactory flexibility when the binder system is based on resins having terminal reactive groups. Yet for these particular case, the derived coatings do not meet high requirements for solvent resistance.

Binder systems having “in chain” unsaturations, thus increasing the network density upon curing, tremendously increase solvent resistance, yet deteriorates flexibility.

Powder coatings characterised in that the binder comprises an acrylic copolymer having several side chains containing unsaturated groups are claimed in WO 93/25596 (DSM).

Mixtures of (meth)acrylyl group containing acrylic copolymers and terminal methacrylyl group containing semi-crystalline polyesters are claimed in WO [98/18874] (UCB).

Powder coatings comprising as a binder a mixture of an unsaturated polyester and an oligomer having a plurality of allyl groups, vinyl groups or methacrylate functional groups are claimed in e. g. U.S. Pat. No. 5,763,099 and U.S. Pat. No. 5,703,198 among others. The unsaturated polyesters are obtained from reaction of polyols with [POLYCARBOXYLIC] acids, the unsaturation being obtained from incorporation of unsaturated diacids or the corresponding anhydrides. The coatings derived prove good flow, scratch and chemical resistance.

It now has been surprisingly found that radiation curable powder coating compositions having as binder a particular mixture of at least one ethylenically unsaturated resin having “in chain” unsaturated groups and at least one ethylenically unsaturated (hydrogenated) polyphenoxy resin having functional groups capable of reacting with the “in chain” unsaturations, exhibit an excellent and unique combination of physical properties such as smoothness, hardness and chemical resistance along with an outstanding flexibility.

The radiation curable powder coating compositions thus are useful for applications such as coil coating and PVC flooring among others.

It is an object of this invention to solves some or all of the problems associated with the prior art for example as described herein, for example to provide powder compositions capable of being cured by radiation upon melting.

Therefore broadly in accordance with the invention there is provided a radiation-curable powder coating composition which comprises: a) from about 10% to about to 90% by weight of an ethylenically unsaturated telechelic polyester and/or acrylic telechelic copolymer; b) from about 10% to about 90% by weight of an ethylenically unsaturated non aromatic polyoxy resin which comprises at least one vinyl group, allyl group, (meth) acrylate ester group; unsaturated diacid and/or unsaturated anhydride; and [C)] optionally up to about 30% by weight of an ethylenically unsaturated oligomer.

Another aspect of the invention provides a radiation-curable powder coating composition which comprises: a) 10 to 90% weight of an ethylenically unsaturated polyester and/or acrylic copolymer having “in chain” unsaturation from 0.35 to 3.50 milliequivalents of double bonds per gram of resin b) 10 to 90% weight of an ethylenically unsaturated (hydrogenated) polyphenoxy resin having vinyl groups, allyl groups, (meth)acrylate ester groups or a diacid or anhydride containing unsaturated groups c) 0 to 30% weight of an ethylenically unsaturated oligomer which has at least one functional group selected from a (meth)acrylate ester group, an allyl group, a vinyl group or a diacid or anhydride containing unsaturated group.

The ethylenically unsaturated polyesters of the present invention may be amorphous or semi-crystalline and are preferably hydroxyl and/or carboxyl acid group terminated polyesters.

The polyesters may be prepared from an acid constituent which contains from 50 to 95% mole of an aliphatic, cycloaliphatic or aromatic polyacid and from 5 to 50% mole of an unsaturated polyacid with an aliphatic or cycloaliphatic polyol.

Examples of suitable aliphatic, cycloaliphatic or aromatic acids comprise among others: phthalic acid, isophthalic acid, terephthalic acid, 1,2-cyclohexanedicarboxylic acid, 1,3-cyclohexanedicarboxylic acid, 1,[4-CYCLOHEXANEDICARBOXYLIC] acid, succinic acid, glutaric acid, adipic acid, pimelic acid, suberic acid, azelaic acid, sebacic acid, 1,12-dodecanedioic acid, trimellitic acid, pyromellitic acid and their anhydrides, alone or as a mixture.

The unsaturated polyacids used for the preparation of the polyesters of the present invention may be selected from fumaric acid, maleic acid, itaconic acid, citraconic acid, mesaconic acid used in a mixture or alone.

Examples of suitable aliphatic or cycloaliphatic polyols comprise among others: ethylene glycol, 1,3-propanediol, 1,4-butanediol, 1,5-pentanediol, [1,6-HEXANEDIOL,] 1,[7-HEPTANEDIOL,] 1,8-octanediol, 1,9-nonanediol, 1,10-decanediol, 1,[11-UNDECANEDIOL,] 1,12-dodecanediol, 2-methyl-1,3-propanediol, neopentyl glycol, [2-BUTYL-2-METHYL-1,] 3-propanediol, hydroxy pivalate ester of neo-pentyl glycol, 1,[4-CYCLOHEXANEDIOL,] 1,[4-CYCLOHEXANEDIMETHANOL,] hydrogenated Bisphenol A, 2,2,4,[4-TETRAMETHYL-1,] 3-cyclobutanediol, 4,8-bis [(HYDROXYMETHYL)-TRICYCLO-[5,]2,[1,][02 6]-DECANE.] The polyesters of the present invention may be prepared according a procedure comprising one or more reaction steps.

For the preparation of the polyesters of the invention it is preferred to use a conventional reactor equipped with a stirrer, an inert gas (nitrogen) inlet, a distillation column connected to a water-cooled condenser and a thermometer connected to a thermoregulator.

The [ESTERIFICATION] conditions used for the preparation of these polyesters can be conventional, namely that it is possible to use an ordinary esterification catalyst e. g. derived from tin, such as dibutyltin oxide, dibutyltin dilaurate or n-dibutyltin trioctoate, or derived from titanium, such as tetrabutyl titanate, in the proportion of e. g. 0 to 1% by weight of the reactants, and optionally to add [ANTIOXIDANTS,] such as the phenol compounds Irganox 1010 (Ciba) or Ionol CP (Shell) or stabilisers of phosphonite or phosphite type, such as tributyl phosphite [OC.] triphenyl phosphite, in the proportion of e. g. 0 to 1% by weight of the reactants.

The polyesterification is generally carried out at a temperature which is gradually increased from 130 to approximately 180 to [250° C.,] first at normal pressure and then under reduced pressure at the end of each step of the process, these conditions being maintained until a polyester is obtained which exhibits the desired hydroxyl and/or acid number. The degree of esterification is monitored by determination of the amount of water formed during the reaction and of the properties of the polyester obtained, for example the hydroxyl number, the acid number, the molecular weight and/or the viscosity.

The polyesters may be characterised with an acid number [(AN)] and/or an hydroxyl number [(OHN)] ranging from 10 to 100 mg KOH/g and preferably from 25 to 75 mg KOH/g, a number average molecular weight (Mn) from 800 to 16 000 and preferably from 1 300 to 8 [500,] a glass transition temperature (Tg) from 40 to [85° C.] when the polyester is amorphous, or a melting temperature from 60 to [150° C.] and a glass transition temperature of less than [50° C.] when the polyester is semi-crystalline, a degree of unsaturation ranging from 0.2 to 4.0 and preferably from 0.5 to 2.5 milliequivalents of double bonds per gram of polyester and an ICI cone/plate viscosity of less than 50 000 [MPA.] s measured at [200° C.]

These polyesters further can be converted into (meth)acryloyl group end-capped polyesters from the reaction of a diisocyanate with a hydroxyalkyl(meth)acrylate and the terminal hydroxyl groups of the polyester or from the reaction of glycidyl(meth)acrylate and the terminal carboxyl groups of the polyester.

The hydroxyalkyl(meth)acrylate used for reaction with the diisocyanate in the above reaction is preferably selected from hydroxyethyl(meth)acrylate, 2- or 3-hydroxy propyl(meth)acrylate, 2-, 3- and 4-hydroxybutyl(meth)acrylate and the like.

The diisocyanate used for the reaction with the hydroxyalkyl(meth)acrylate and the hydroxyl group containing polyester in the above reaction is preferably selected from [L-ISOCYANATO-3,] 3,5-trimethyl-5-isocyanatomethyl-cyclohexane (isophorondiisocyanate, IPDI), tetramethyl-[XYLENEDIISOCYANATE][(TMXDI),] hexamethylenediisocyanate (HDI), trimethylhexamethylene diisocyanate, [4,][4&APOS;-DIISOCYANATODICYCLOHEXYLMETHANE,] 4,4′-diisocyanatodiphenylmethane, these technical mixtures with 2,4-diisocyanatodiphenylmethane and also the higher homologues of above mentioned diisocyanates, 2,4-diisocyanatotoluene and technical mixtures of them with 2,6-diisocyanatotoluene, as well as the copolymerisation product of [A,] a′-dimethyl-meta-[ISOPROPENYLBENZYLISOCYANATE (TMI).]

The polyesters containing (meth)acryloyl groups can be prepared in one of the following ways: On completion of the above described polycondensation, the hydroxyl or carboxyl functional group containing polyester in the molten state, which is found in the reactor, is allowed to cool to a temperature between 100 and 160° C., and a radical polymerisation inhibitor, such as phenothiazine or an inhibitor of the hydroquinone type, is added in a proportion of e. g. 0.01 to 1% with respect to the weight of the polyester and the nitrogen is replace by an oxygen inlet. When started from a hydroxyl group containing polyester, a substantially equivalent amount of hydroxyalkyl(meth)acrylate is added thereto. When all the hydroxyalkyl(meth)acrylate is added, an equivalent amount of diisocyanate is slowly added to the mixture. A catalyst for the hydroxyl/isocyanate reaction can optionally be used. Examples of such catalysts include organo-tin compounds (e. g. dibutyltin dilaurate, dibutyltin dimaleate, dibutyltin oxide, stannous octoate, [1,][3-DIACETOXY-1,][1,][3,] 3-tetrabutyl-distanoxane). These catalysts are preferably used in an amount of 0 to 1% with respect to the weight of the polyester.

Otherwise, when started from a polyester containing carboxyl groups, a substantially equivalent amount of glycidyl(meth)acrylate is added thereto. A catalyst for the [ACID/EPOXY] reaction can optionally be used. Examples of such catalysts include amines (e. g. 2-phenylimidazoline), phosphines (e. g. triphenylphosphine), ammonium salts (e. g. tetrabutylammonium bromide or [TETRAPROPYLAMMONIUM] chloride), phosphonium salts (e. g. ethyltriphenylphosphonium bromide or tetrapropylphosphonium chloride). These catalysts are preferably used in an amount of 0.05 to 1% with respect to the weight of the polyester.

The degree of progression of the reaction is monitored by determination of the properties of the polyester obtained, for example the hydroxyl number, the acid number, the degree of unsaturation and/or the content of free glycidyl(meth)acrylate or [HYDOXYALKYL](meth)acrylate.

The unsaturated polyesters thus obtained prove a degree of telechelic(meth)acryloyl unsaturation ranging from 0.0 to 2.0 milliequivalents of double bonds per gram of polyester.

The ethylenically unsaturated acrylic copolymers of the powder composition of the present invention are prepared from the reaction of ethylenically unsaturated monomers having functional groups with an acrylic copolymer having functional groups being capable of reacting with the functional groups of the ethylenically unsaturated group containing monomers.

The acrylic copolymer having reactable functional groups is composed of from 40 to 95% mole of at least one acrylic or methacrylic monomer, from 0 to 60% mole of at least one other ethylenically unsaturated monomer and from 5 to 60% mole of an ethylenically unsaturated monomer having functional groups selected from epoxy, carboxyl, hydroxyl or isocyanate groups.

The ethylenically unsaturated acrylic copolymer of the powder composition of the present invention can be prepared accordingly a two step process.

In a first step the acrylate copolymer can be prepared in a conventional polymerisation process, such as polymerisation in bulk, in emulsion, or in solution in an organic solvent, in which a certain portion of functional monomer is copolymerised to obtain a functionalised acrylate copolymer. This functional monomer, which is usually present in amounts of between 5 and 60% mole, is preferably an epoxy-functional monomer, for example on the basis of glycidyl(meth)acrylate. However, acid-functional monomers, for example on the basis of (meth)acrylic acid, hydroxyl-functional monomers, for example on the basis of hydroxyethyl(meth)acrylic, or isocyanate-functional monomers, for example on the basis [OF TMI] (benzene, 1-(1-isocyanato-[1-METHYLETHYL)-4-(1-METHYLETHENYL))] from American Cyanamid or MOI (2-[ISOCYANATOETHYLMETHACRYLATE)] from Shawo Denko also can be used. The monomers are copolymerised in the presence of free-radical initiator such as benzoyl peroxide, tert-butyl peroxide, decanoyl peroxide, azo-bis-isobutyronitrile, and the like, in an amount of from 0.1 to 5% by weight of the monomers. Useful monomers for the preparation of the acrylic copolymer are methyl(meth)acrylate, ethyl(meth)acrylate, propyl(meth)acrylate, n-butyl(meth)acrylate, isobutyl(meth)acrylate, tert-butyl(meth)acrylate, 2-ethylhexyl(meth)acrylate, stearyl(meth)acrylate, tridecyl(meth)acrylate, cyclohexyl(meth)acrylate, benzyl(meth)acrylate, benzyl(meth)acrylate, phenyl(meth)acrylate, dimethylaminoethyl(meth)acrylate, diethylaminoethyl(meth)acrylate, polysiloxane(meth)acrylate and caprolactone(meth)acrylate. These monomers usually are present in amounts between about 40 and about 95% mole.

Other copolymerisable monomers, which can be present in amounts between 0 and 60% mole, are for example styrene, a-methylstyrene, vinyltoluene, acrylonitrile, [METHACRYLONITRILE,] vinyl acetate, vinyl propionate, acrylamide, [METHACRYLAMIDE,] methylolmethacrylamide, vinylchloride, ethylene, propylene and C4-20 [A-OLEFINS.]

In the second step an addition reaction is carried out between the functionalised monomer of the acrylate copolymer obtained from the first step and the ethylenically unsaturated group containing compound that can react with said functional monomer. The compound that can react respectively is for example (meth)acrylic acid, maleic anhydride, [(β-]methyl)glycidyl(meth)acrylate, allylglycidyl ether, MOI, hydroxyethyl(meth)acrylate, hydroxybutylvinyl ether, allyl alcohol The addition reaction of the second step can be done either in bulk or in solvent. Typical solvents are toluene, xylene, n-butylacetate, etc. The compound containing an unsaturated group that can react with the functionalised acrylate polymer is added at temperatures between 50 and [150° C.] The mixture is stirred for several hours. The progress of the reaction is followed by titration.

The ethylenically unsaturated acrylic copolymer of the powder composition of the present invention exhibit one or more of the following characteristics: a number average molecular weight (Mn) from 1000 to 8000 and preferably from 2 000 to 6 000 measured by GPC; a degree of unsaturation from 0.35 to 3.50 and preferably from 0.5 to 2.5 milliequivalents of double bounds per gram of acrylic copolymer; an ICI cone/plate melt viscosity of less than 50 000 [MPA.]s measured at [200° C.] according to ASTM D4287; a glass transition temperature (Tg) from 45 to [100° C.] as determined by DSC according to ASTM D3418. The ethylenically unsaturated (hydrogenated) polyphenoxy resin may be obtained or obtainable from the reaction of the glycidyl group of the (hydrogenated) polyphenoxy resin with the carboxylic acid group [OF:] a mono or polyfunctional unsaturated carboxylic acid or its anhydride such as (meth)acrylic acid, maleic acid, fumaric acid, itaconic acid, citraconic acid, mesaconic acid; the reaction product of a methacryloyl, a vinyl or allyl group containing alcohol such as allyl alcohol, [HYDROXYBUTYLVINYLETHER,] hydroxy ethyl [(METH)]acrylate, with an anhydride such as phthalic anhydride, succinic anhydride; and/or the reaction product of an allyl or vinyl glycidyl ether with a diacid such as isophthalic acid, terephthalic acid, [1,][2-CYCLOHEXANEDICARBOXYLIC] acid, 1,3-cyclohexanedicarboxylic acid, 1,4-[CYCLOHEXANEDICARBOXYLIC] acid, succinic acid, glutaric acid, adipic acid, pimelic acid, suberic acid, azelaic acid, sebacic acid, 1,12-dodecanedioic acid.

For the preparation of the ethylenically unsaturated group containing (hydrogenated) polyphenoxy resin, use is generally made of a conventional reactor equipped with a stirrer, an inlet for oxygen, an inlet for the ethylenically unsaturated carboxylic acid group containing compound and a thermometer connected to a thermoregulator. To the epoxy resin standing at a temperature between 100 and [150° C.,] a radical polymerisation inhibitor is added in a proportion of e. g. 0.01 to 1% with respect to the weight of the epoxy resin. A substantial equivalent amount of the ethylenically unsaturated carboxylic acid group containing compound is then slowly added to the molten epoxy resin. A catalyst for the [ACID/EPOXY] reaction can optionally be used. Examples of such catalysts include amines (e. g. 2-phenylimidazoline), phosphines (e. g. triphenyl phosphine), ammonium salts (e. g. tetrabutylammonium bromide or tetra propyl ammonium chloride), phosphonium salts (e. g. [ETHYLTRIPHENYLPHOSPHONIUM] bromide or tetra propyl phosphonium chloride). These catalysts are preferably used in an amount of 0.05 to 1% with respect to the weight of the epoxy [RESIN.<<] The degree of progression of the reaction is monitored by determination of the properties of the ethylenically unsaturated group containing resin obtained, such as acid number, hydroxyl number and the degree of unsaturation.

The ethylenically unsaturated group containing (hydrogenated) polyphenoxy resins incorporated in the compositions in accordance with the present invention, preferably exhibit a degree of unsaturation of 0.2 to 6.0, particularly of 0.5 to 4.5 milliequivalents of double bonds per gram of resin, and in a specifically preferred embodiment additionally exhibit one or more of the following characteristics: a number average molecular weight (Mn) from 450 to 5000, preferably between 650 and 3500, measured by gel permeation chromatography [(GPC)] a glass transition temperature (Tg) determined by differential scanning calorimetry (DSC) according to ASTM [D3418,] from 30 to [80° C.] aviscosity in the molten state measured at [200° C.] with a cone/plate viscometer [(KNOWN UNDER] the name of ICI viscosity) according to ASTM [D4287,] of less than 20 000 [MPA.] s.

Besides the ethylenically unsaturated polyester and/or acrylic copolymer [HAVING “IN]chain” unsaturations and the ethylenically unsaturated (hydrogenated) polyphenoxy resin, the powder compositions of the present invention may contain up to 30% weight of an ethylenically unsaturated oligomer.

The ethylenically unsaturated oligomer may be selected from: allyl ether-ester group containing oligomers, such as the ester of trimethylolpropane diallylether or pentaerythritol triallylether and a [POLYCARBOXYLIC] acid or anhydride, for example the trimethylolpropane diallylether diester and triester of [TRIMELLLTIC] anhydride or the pentaerythritol triallylether diester of adipic acid oligomers containing allyl-groups and urethane-groups for example those obtained from the reaction of allyl alcohol, trimethylolpropane diallylether, pentaerythritol triallylether with isophoronediisocyanate, toluenediisocyanate, hexamethylene diisocyanate, oligomers such as triallylcyanurate, triallylisocyanurate, diallylphthalate vinylether group containing oligomers such as butylvinylether, cyclohexyldimethanol divinylether, butyldivinylether, triethyleneglycoldivinylether, hydroxybutylvinylether polyurethaneoligomers having vinylether and/or allylether [AND/OR] (meth)acrylate ester end-groups and optionally a polyether, polyester or polycarbonate backbone, prepared from the reaction of respectively [HYDROXYALKYLVINYLETHER,] [HYDROXYALKYLALLYLETHER] or hydroxyalkyl (meth)acrylate with a polyisocyanate and optionally a hydroxyl functional oligomer, this oligomer being a polyether, polyester or polycarbonate triacrylate and [TRIMETHACRYLATE] of tris(2-hydroxyethyl)isocyanurate The ethylenically unsaturated amorphous and/or semi-crystalline polyester and/or acrylic copolymer along with the ethylenically unsaturated (hydrogenated) polyphenoxy resin optionally along with the ethylenically unsaturated oligomer all described above, intended to be used as binders in the preparation of powder compositions curable by UV radiation or by accelerated electron beams, it being possible for the said compositions to be used in particular as varnishes and paints which e. g. lend themselves to application according to the technique of deposition by means of a triboelectric or electrostatic spray gun or according to the technique of deposition in a fluidised bed. The radiation curable powder compositions can be used as varnishes or paints as such or, if desired, the compositions can be used to prepare the varnishes or paints by adding, further constituents conventionally used in the preparation of powder varnishes and paints.

Therefore, the present invention also relates to the powder varnish or paint obtained using these compositions. Finally, the present invention also relates to a process for coating an article more particularly a metal article comprising the application to the said article of a radiation curable powder composition in accordance with the invention by deposition such as by spraying with a triboelectric or electrostatic spray gun or by deposition in a fluidised bed, followed by the melting of the coating thus obtained such as by heating at a temperature of 80 to [150° C.] for a time of e. g. approximately 0.5 to 10 minutes and by the curing of the coating in the molten state by [UV] irradiation or by accelerated electron beams.

For the radiation curing of the powder compositions in accordance with the invention with accelerated electron beams, it is not necessary to use a photo-initiator, seeing that this type of radiation provides by itself alone a production of free radicals which is sufficiently high for the curing to be extremely rapid. In contrast, when it concerns the photo-curing of the powder composition according to the invention with radiation where the wavelengths are between 200 and 600 nm [(UV]radiation), the presence of at least one photo-initiator is essential.

The photo-initiators which can be used according to the present invention are chosen from those commonly used for this purpose.

The appropriate photo-initiators which can be used, are aromatic carbonyl compounds, such as benzophenone and its alkylated or halogenated derivatives, anthraquinone and its derivatives, thioxanthone and its derivatives, benzoin ethers, aromatic or non-aromatic alphadiones, benzil dialkyl acetals, acetophenone derivatives and phosphine oxides.

Photo-initiators which may suitable, are, for example, 2,[2&APOS; -DIETHOXYLACETOPHENONE, 2-, 3- OR]4-bromoacetophenone, [2,] 3-pentanedione, [HYDROXYCYCLOHEXYLPHENYLKETONE,] [BENZALDEHYDE,] benzoin, benzophenone, 9,[10-DIBROMOANTHRACENE,] 2-hydroxy-2-methyl-1-phenylpropan-1-one, 4,4′-dichlorobenzophenone, xanthone, thioxanthone, benzildimethylketal, diphenyl(2,4,6trimethylbenzyl)phosphine oxide, and the like. It may be optionally advantageous to use a photo-activator, such as [TRIBUTYLAMINE,] [2-(2-AMINOETHYLAMINO)]ethanol, [CYCLOHEXYLAMINE,] diphenyl amine, [TRIBENZYLAMINE] or [AMINOACRYLATES] such as, for example, the addition product of a secondary amine, such as dimethylamine, [DIETHYLAMINE,] [DIETHANOLAMINE,] and the like, with a polyol polyacrylate, such as the diacrylate of trimethylolpropane, 1,6-hexanediol, and the like. The powder compositions in accordance with the invention can contain 0 to 15 and preferably 0.5 to [8] parts of photo-initiators for 100 parts by weight of the binder in the composition in accordance with the invention.

The radiation curable powder compositions and powder varnishes or paints, respectively, in accordance with the invention can also contain various additional substances conventionally used in the manufacture of powder paints and varnishes. The additional substances optionally added to the radiation-curable powder compositions in accordance with the invention, e. g. to prepare the powder varnishes or paints are, inter alia, compounds which absorb [UV] radiation, such as Tinuvin 900 (Ciba), light stabilisers based on sterically hindered amines (for example Tinuvin 144 from Ciba), fluidity-regulating agents such as Resiflow PV5 (Worlee), Modaflow (Monsanto), Acronal 4F (BASF) or Crylcoat 109 (UCB), degassing agents such as benzoin and the like.

To the radiation-curable powder composition according to the present invention, further can be added a variety of coating properties modifying substances such as polytetrafluoroethylene modified polyethylene waxes (e. g. Lanco [WAX TF] 1830 from [LUBRIZOL),] polyethylene waxes (e. g. Ceraflour 961 from BYK Chemie), polypropylene waxes (e. g. Lanco Wax PP 1362 from Lubrizol), polyamide waxes (e. g. Orgasol 3202 D NAT from ELF Atochem), organosilicones (e. g. Modarez S304P from Protex), etc., or blends of them. These modifying substances are optionally added from 0 to 10 parts for 100 parts by weight of the binder in the composition according to the invention. A variety of pigments and inorganic fillers can also be added to the radiation curable powder compositions in accordance with the invention. Mention will be made, as examples of pigments and fillers, of metal oxides, such as titanium oxide, iron oxide, zinc oxide, and the like, metal hydroxides, metal powders, sulphides, sulphates, carbonates, silicates such as, for example, aluminium silicate, carbon black, talc, kaolins, barytes, iron blues, lead blues, organic reds, organic maroons, and the like.

These additional substances are used in the usual amounts, it being understood that if the radiation curable powder compositions in accordance with the present invention are used as varnishes, the addition of additional substances having pacifying properties should be omitted.

For the preparation of the radiation curable powder compositions of the present invention the amorphous and/or semi-crystalline polyester and/or the acrylic copolymer and the (hydrogenated) polyphenoxy resin all containing ethylenically unsaturated groups, and/or the ethylenically unsaturated oligomer, if present, optionally the photo-initiator, optionally the various additional substances conventionally used for the manufacturing of powder paints and varnishes, and optionally the coating properties modifying substances are dry mixed, for example in a tumbler mixer. The mixture is then homogenised at a temperature ranging from 60 to [150° C.] in an extruder, for example in a Buss Ko-Kneter single screw extruder or a twin screw extruder [OF WERNER-PFLEIDERER,] APV-Baker or Prism type. The extrudate is then allowed to cool, is ground and sieved in order to obtain a powder in which the size of the particles is preferably between 10 and 150 [PM.]

The powder paints and varnishes thus obtained, are entirely suitable for application to the article to be coated by conventional techniques, that is to say by the well-known technique of e. g. deposition in a fluidised bed or by application with a triboelectric or electrostatic spray gun. After having been applied to the article concerned, the coatings deposited are heated e. g. in [A] forced circulation oven or by means of infrared lamps at a temperature of 80 to [150° C.] for a time of e. g. approximately 0.5 to 10 minutes for the purpose of obtaining the melting and the spreading of the powder particles as a smooth, uniform and continuous coating at the surface of the said article. The molten coating is then cured by radiation, such as W light emitted, for example, by medium pressure mercury vapour W radiators, of preferably at least 80 to 250 W/linear cm, or by any other well-known source of the state of the art, at a distance of e. g. approximately 5 to 20 cm and for a time sufficient to cure the coating, such as 1 to 60 seconds.

The molten coating can also be cured with accelerated electron beams of preferably at least 150 keV, the power of the devices employed being a direct function of the thickness of the composition layer to be cured by polymerisation.

The invention is also concerned by articles partially or entirely coated by the coating processes.

The radiation curable powder compositions in accordance with the invention though they can be applied to the most diverse substrates, such as, for example, metal, paper, cardboard, wood, fibre board, textiles, plastics, such as polycarbonates, poly(meth)acrylates, polyolefins, polystyrenes, poly(vinylchloride)s, polyesters, polyurethanes, polyamides, copolymers such as acrylonitrile-butadiene-styrene (ABS) or cellulose acetate butyrate, and the like.

The radiation curable powder compositions in accordance with the invention can also be formulated in toner compositions, such as any dry or liquid toner useful in electroreprography.

Further aspects and features of the invention are given in the claims.

This invention will further be illustrated by the following examples, which are purely exemplary of the use of the invention.

### EXAMPLE 1

synthesis of an ethylenically unsaturated polyester A mixture of 591.8 parts of neopentyl glycol and 2.0 parts of n-dibutyltin trioctoate catalyst is placed in a conventional four-necked round bottom flask.

The flask contents are heated while stirring under nitrogen to a temperature of circa [140° C.]

Thereupon [386.] 4 parts of terephthalic acid and 257.6 parts [OF FUMARIC] acid along with 0.2 parts of di-t-butylhydroquinone are added while stirring and the mixture is gradually heated to a temperature [OF 225° C.] Distillation starts from about [190° C.] After about 95% of the theoretical quantity of water is distilled, a transparent polymer is obtained and a vacuum of 50 mm Hg is gradually applied till following characteristics are measured: acid value of 3 mg KOH/g; hydroxy value of 48 mg KOH/g; unsaturation of 2.2 meq/g; [ICIL75° C.] of 3500 [MPA.][S,] [TGQUENCHED] (DSC) of [48° C.]; Mn (GPC) of 2240.

### EXAMPLE 2

synthesis of an ethylenically unsaturated polyphenoxy resin Step 1 To a conventional four-necked round bottom flask are added 1000 ml of chloroform and 105 parts of succinic anhydride. The flask contents are heated till [55° C.] and 120 parts of 4-[HYDROXYBUTYLVINYLETHER] along with 0.1 parts of di-t-butylhydroquinone are added gradually in 1 hour under oxygen. Once the addition is completed the mixture is further stirred under oxygen for another three hours until an acid number of 240-280 mg KOH/g and an hydroxyl number of less than 20 mg KOH/g is measured. The flask content then is emptied and dried in a rotary evaporator at [50° C.] under vacuum during 1 hour.

Step [2] Then, 775 parts of Araldite GT7004, a Bisphenol A-type epoxy resin, are heated in a conventional four-necked round bottom flask to a temperature of [140° C.] under oxygen.

Subsequently 0. [8] parts of ethyltriphenylphosphoniumbromide are added and the addition of 225 parts of Step 1 adduct containing 0.2 parts of di-t-butylhydroquinone is started. The addition in completed in three hours. One hour after the completion of the Step 1 addition a resin with following characteristics is obtained: acid value of 8 mg KOH/g; unsaturation of 1 meq/g; [TGQUENCHED] (DSC) [OF 45° C.] and Mn (GPC) of 1900.

### EXAMPLE 3

synthesis of a vinylether functionalised oligomer The vinylether functionalised oligomer is prepared according the recipe and procedure as described in experiment 2 of U.S. Pat. No. 5,703,198.

A 4-liter cylindrical reactor was provided with a thermometer, a stirrer and a reflux condenser, and filled with 555 parts of 1,6-hexanediisocyanate, 0.6 parts of dibutyltin laurate and 21 of chloroform. While supplying a constant flow of nitrogen to the vessel, 766 parts of 4-[HYDROXYBUTYLVINYLETHER] were added drop-wise over the course of about three hours, during which time the reaction mixture was heated to about [55° C.] After about eight hours a sediment had formed, which was filtered, washed with hexane, and dried under vacuum.

The reaction product had a melting range of about [90-108° C.]

### EXAMPLE 4

Curing of unpigmented powder paint varnish with W radiation A mixture of [510] parts of the ethylenically unsaturated polyester of example 1,320 parts of the ethylenically unsaturated polyphenoxy resin of example 2 and 170 parts of the ethylenically unsaturated oligomer of example 325 parts of Irgacure 2959 [(A-HYDROXYKETONE)] (Ciba) and 10 parts of BYK361 (BYK Chemie) is homogenised at a temperature of approximately 70 to [100° C.] in a Prism 16 mm (L/D=15/1) twin screw extruder (from the company Prism) and the extrudate is ground in a grinder of Alpine 100 UPZ (from the company Alpine). To complete, the powder is sieved in order to obtain a size of the particles between 10 and [110 UM.]

The powder formulated as described above with the binder composition in accordance with the present invention is applied with an electrostatic spray gun at a voltage of 60 kV on untreated cold rolled steel at a film thickness of 40 to 100 um.

The coating deposited is then subjected to melting in a medium infrared/convection oven [(TRIAB)] at a temperature of [140° C.] during a time of approximately 3 minutes, and is then subjected to irradiation with ultraviolet light emitted by a 160 W/cm medium pressure mercury vapour [UV-]bulb (Fusion UV Systems Ltd.) with a total UV dose of 2000 [MJ/CM2.]

The powder coating obtained was tested; following results were observed: the visual assessment: good; smooth and glossy appearance without any defect; pencil hardness: 3 H, according to the scratch Hardness Tester according to [WOLFF-WILBORN]; MEK resistance: >200, which corresponds to the number of twofold rubbing movements (to and fro) with a cotton pad impregnated with MEK which does not detrimentally affect the appearance of the surface of the cured film; Direct Impact: >100 kg. cm, the value of resistance to direct impact (DI) in kg. cm, according to ASTM D2795 on cold rolled steel; Reverse Impact: >100 kg. cm, the value of resistance to direct impact (RI) in kg. cm, according to ASTM D2795 on cold rolled steel; T-bending: <2T, according to the ASTM [D4145-83] T-bending test; and Adhesion: 4-5B, where 5B: the edges of the cuts are completely smooth; none of the squares of the lattice is detached 4B: small flakes of the coating are detached at intersections; less than 5% of the area is affected.

In a second experiment the powder of example 4 was sprayed on a PVC sheet.

The coating was subjected to melting during 90 seconds at [120° C.] in a medium infrared/convection oven and then subjected to irradiation with ultraviolet light emitted by a 160 W/cm medium pressure mercury vapour UV-bulb (Fusion UV Systems Ltd.) with a total W dose of 2000 mJ/cm. The coating proved a good aspect, good MEK resistance (>200 double MEK-rubs) and no cracks on bending the PVC sheet.

Example 4 demonstrates that the binder composition according to the present invention can be used as a powder paint on substrates intended for end-applications where an excellent flexibility and an outstanding solvent resistance is needed, such as coil coating and PVC flooring.

While the invention has been described in detail and with reference to specific embodiments thereof, it will be apparent to one of ordinary skill in the art that various changes and modifications can be made therein without departing from the spirit and scope thereof

1. A radiation-curable powder composition which comprises: a) a first component comprising from about 10% to about to 90% by weight of an ethylenically unsaturated telechelic polyester and/or acrylic telechelic copolymer; b) a second component comprising from about 10% to about [90%] by weight of an ethylenically unsaturated non aromatic polyoxy resin; and c) optionally a third component comprising up to about 30% by weight of an ethylenically unsaturated polymer precursor.

2. A radiation-curable powder composition which comprises a) a first component comprising from about 10% to about to 90% by weight an ethylenically unsaturated polyester and/or acrylic [COPOLYMER HAVING AN “IN] chain” unsaturation from 0.35 to 3.50 milliequivalents of double bonds per gram; b) a second component comprising from about 10% to about to 90% by weight of an ethylenically unsaturated (hydrogenated) polyphenoxy resin comprising a vinyl group, an allyl group, a (meth)acrylate ester group or a diacid or anhydride containing unsaturated groups; c) a third component from about 0 to about 30% by weight of an ethylenically unsaturated oligomer.

3. A composition according to either preceding claim, in which the first component comprising an ethylenically unsaturated polyester obtained and/or obtainable by reacting (i) an acid component comprising from 50 to 95% mole of an aliphatic, cycloaliphatic or aromatic polyacid and from 5 to 50% mole of an unsaturated polyacid; with (ii) an alcohol component comprising an aliphatic and/or cycloaliphatic polyol.

4. A composition according to claim 3, obtained and/or obtainable from an unsaturated polyacid which comprises maleic acid, fumaric acid, itaconic acid, citraconic acid, mesaconic acid and/or any mixtures thereof.

5. A composition according to any preceding claim, in which the first component comprises an ethylenically unsaturated polyester having hydroxyl and/or carboxylic acid end groups.

6. A composition according to claim 5, where the polyester is characterised by at least one of the following properties and any combinations thereof: [(1)] an acid and/or hydroxyl number from about 10 to about 100 (preferably from about 25 to about 75) mg KOH/g; (II) a number averaged molecular weight from about 800 to about 16 000 (preferably from about [1,300] to about [8,]500) daltons; [(III)] a melt viscosity (measured by the cone plate method at [200° C.)] of less than about 50,000 [MPA.] s; [(IV)] a degree of unsaturation from about 0.2 to about 4.0 (preferably from about 0.5 to about 2.5) milliequivalents of double bonds per gram of polyester; [(V) A] glass transition temperature from about 40 to about [85° C.]; and/or (VI) a melting point from about 60 to about [150° C.] and a glass transition temperature of less than about [50° C.]

7. A composition according to any of the preceding claim, where the first component is obtained and/or obtainable by reacting: (a) a diisocyanate; a hydroxyalkyl(meth)acrylate and an ethylenically unsaturated polyester; or (b) a glycidyl(meth)acrylate and an ethylenically unsaturated polyester.

8. A composition according to any preceding claim, in which the first component comprises an ethylenically unsaturated polyester with a degree of telechelic unsaturation from about 0 to about 2 milliequivalents of double bonds per gram of polyester.

9. A composition according to any preceding claim, in which the first component comprises an ethylenically unsaturated acrylic copolymer obtained and/or obtainable by reacting: (a) an acrylic copolymer comprising functional groups obtained and/or obtainable from (i) from about 40 to about 95 mole % of at least one monomer having acrylic or methacrylic groups, (ii) optionally up to about 60 mole % of another ethylenically unsaturated monomer; and (iii) from about 5 to about 60 mole % of an ethylenically unsaturated monomer having a functional group capable of reacting with one or more: epoxy, carboxylic acid, hydroxy and/or isocyanate.
(b) a monomer having an ethylenically unsaturated group and a functional group capable of reacting with one or more: epoxy; carboxylic acid, hydroxy and/or isocyanate.

10. A composition according to any preceding claim, in which the first component comprises an ethylenically unsaturated acrylic copolymer characterised by at least one of the following properties and any combinations thereof: [(I) ] a number averaged molecular weight from about 1000 to about 8000 (preferably from about 2,000 to about 6,000) daltons; (II) a glass transition temperature from about 45 to about [100° C.]; (III) a degree of unsaturation from about 0.35 to about 3.50 (preferably from about 0.5 to about 2.5) milliequivalents of double bonds per gram of acrylic copolymer; and/or [(III)] a melt viscosity (measured by the cone plate method at [200° C.)] of less than about 50,000 [MPA.] s.

11. A composition according to any preceding claim, in which the first component comprises an acrylic copolymer and the third component comprises an ethylenically unsaturated monomer comprising at least one: (meth)acrylate ester group, allyl group, vinyl group, unsaturated diacid and/or unsaturated anhydride, the monomer being capable of reacting with at least one carboxylic acid, epoxy, isocyanate and/or hydroxyl group of the acrylic copolymer.

12. A composition according to any preceding claim, in which the second component is obtained and/or obtainable by reacting (a) a (hydrogenated) polyphenoxy resin comprising at least one glycidyl group with (b) the reaction product [OF:] (i) an alcohol comprising a vinyl or allyl group; with an anhydride; (ii) a hydroxyalkyl(meth)acrylate with an anhydride; [AND/OR] (iii) an allyl or vinyl glycidyl ether with a polyacid; a mono or polyfunctional unsaturated carboxylic acid and/or anhydrides thereof.

13. A composition according to any preceding claim, in which the second component is characterised by at least one of the following properties and any combinations thereof: [(1)] a number averaged molecular weight from about 450 to about 5000 (preferably from about 650 to about 3500); (II) a glass transition temperature from about 30 to about [80° C.] (III) a degree of unsaturation from about 0.2 to about 6.0, (preferably from about 0.5 to about 4.5) milliequivalents of double bonds per gram of resin; and/or [(IV) A] melt viscosity (measured by the cone plate method at [200° C.)] of less than about 20,000 [MPA.] s.

14. A composition according to any preceding claim, in which the third component comprises an oligomer comprising at least one functional group selected from a (meth)acrylate ester group, an allyl group, a vinyl group, an unsaturated diacid and/or an unsaturated anhydride.

15. A radiation curable powder composition which additionally comprises up to about 15 (preferably up to about 8) parts by weight of a photo-initiator for every 100 parts by weight of (as a binder) a composition according to any preceding claim.

16. A radiation curable powder composition which additionally comprises up to about 10 parts by weight of at least one substance which is effective in modifying coating properties for every 100 parts by weight of (as a binder) a composition according to any preceding claim.

17. A powder varnish and/or powder paint comprising a radiation curable powder composition according to any preceding claim.

18. A process for coating an article with a composition as claimed in any preceding claim which comprises the steps of (a) depositing the composition on the article (b) melting the coating thus obtained; and (c) exposing the molten coating to radiation sufficient to form a cured coating.

19. A process according to claim 17, in which the coating is melted by heating at a temperature of from about 80 to about [150° C.] (preferably for a time of about 0.5 to about 10.0 minutes).

20. A process according to claim 17 or 18, in which the curing radiation is LTV radiation or an accelerated electron beam.

21. An article partially or entirely coated by the process of any of claims 17 to 19.
